(19) United States
(12) Patent Application Publication
(10) Pub. No.: US 2006/0031391 A1
(43) Pub. Date: Feb. 9, 2006

(54) Universal data-exchange system of sample-processing stations and a method of compiling and managing the aforementioned system

(76) Inventors: Valentin Balter, Menlo Park, CA (US); Vladimir Mordekhay, Menlo Park, CA (US)

Correspondence Address: Valentin Balter, 1045 Lassen Drive, Menlo Park, CA, 94025, US

(21) Appl. No.: 10/913,908

(22) Filed: Aug. 9, 2004

(51) Int. Cl. G06F 15/16

(52) U.S. Cl. 709/217

(57) ABSTRACT

Proposed is a high throughput system composed from individual computer-controlled sample-processing stations, each of which is assigned at least one instrument identifier (ID). Each sample array that has to be processed in the system is uniquely associated with a specific electronic memory that can be accessed by the sample array processing stations of the system. This memory may be located on memory chips built into or removably attached to sample plates that carry the samples to be analyzed, or in a location remote from the sample plates, e.g., in a CPU. The instrument ID specific records of executable commands that are stored in the memory comprise a set of commands for controlling processing of associated sample arrays on a station the type of which matches the ID. Each executable command for the station of a particular type has to be provided with a command definition record (CDR) that includes at least a command name and the processing station ID to which this command is addressed. The system also includes “writing” stations that can not only write the data into the memory but also read the data back from the memory, e.g., for checking the content of the electronic memory, when necessary. If a command specific CDR is available on the specific writing station of the system, then this command can be inputted into the flow of commands from that station.

### CROSS-REFERENCE TO RELATED APPLICATIONS

The present patent application is supported by: U.S. patent application Ser. No. 10/615,733 filed on Jul. 9, 2003 and entitled “Apparatus and Method for Automated Sample Analysis by Atmospheric Pressure Matrix Assisted Laser Desorption Ionization Mass Spectrometry,” U.S. patent application Ser. No. 10/624,399, filed on Jul. 21, 2003 and entitled “A System of Sample Medium Carriers with Built-In Memory Elements and Information Input/Output Station for the Carriers,” and U.S. patent application Ser. No. 10/706,011, filed on Nov. 10, 2003 and entitled “A System for Processing Sample Plates with Built-In Electronic Memory for High Throughput Sample Processing and a Processing Method.”

### FIELD OF THE INVENTION

The present invention relates to the field of chemistry, analytical chemistry and biochemistry, and, in particular, to a universal system composed of a plurality of individual sample-processing stations and to a method of compiling and managing the individual stations of the aforementioned system. More specifically, the invention relates to a system of sample-processing stations that is provided with a data organization pattern that allows for data compatibility and exchange between the stations of different types and manufacturers.

### PRIOR ART AND DISADVANTAGE OF THE PRIOR ART

In a modern biochemical lab, it is common to process chemical, biochemical or medical samples sequentially, utilizing different sample-processing stations. For example, such a station may be a sample loading station, sample cleanup station or a sample analyzing station, such as a mass spectrometer, optical spectrometer, electrochemical detector, etc. An example of such a station for atmospheric pressure laser-assisted desorption ionization (AP-MALDI) mass spectroscopy is described in U.S. patent application Ser. No. 10/615,733 filed by V. Mordekhay on Jul. 9, 2003. The station consists of an autoloading robotic device for loading sample plates and a mass spectrometer equipped with an AP-MALDI ionization source. The station is fully automated, and the movements of all mechanisms and drives are controlled by data preliminarily inputted to a central processing unit provided in the apparatus. This station is well suited for high throughput analysis such as analysis of peptides and proteins. However, integration of this station with sample preparation equipment into a combined highly productive system for analysis of peptides and proteins may present a problem caused by incompatibility between the software used on different sample preparation and sample analysis stations. Furthermore, the time required for specifying each specific sample or result processing method for each of the stations can create a bottleneck in the combined system operation, especially if a large number of samples has to be analyzed by a set of different methods. If a new station has to be introduced into such a system for processing additional samples or result processing steps, such a task may be time-consuming and inefficient.

If an analysis is relatively low in volume, it is common that the aforementioned sample processing information is loaded manually into a mass spectrometer and into the central processing unit for handling the sample carriers. However, when a large number of samples is to be analyzed with the use of automatic loading/unloading devices such as industrial robots or the transportation system of the type described in the aforementioned patent application, it becomes difficult to analyze different samples by different methods, as well as to keep the correct data regarding the sample history, the results of the analysis and the location of various samples in the cells of the sample carriers. It is also difficult to keep information on the exact location of the sample carriers in the storage devices.

One solution of the above problem is described in U.S. patent application No. 10/624,399 filed by V. Mordekhay on Jul. 21, 2003. According to the aforementioned invention, it is proposed to provide the sample plate carriers with resettable built-in memory chips while the units of the sample-processing station are equipped with devices for reading the information stored in the memory chip, as well as for inputting additional information into the memory chip on different stages of sample processing. In the above application, the aforementioned station contains a storage cassette for the carriers. The cassette has an input/output port for selectively entering or extracting information into or from the aforementioned memory chip. This information may relate to the specific sample plates or sample plate carriers that holds the memory element and may relate to positions of the carriers and events that occurred with the samples on the specific sample plates.

The U.S. patent application Ser. No. 10/706,011 filed on Nov. 10, 2003 by V. Mordekhay also presents a method for combining several sample-processing stations into a system. A sample plate processing system described in the above application in its simplest version consists of a sample deposition station with a data input/output unit and a sample-processing station for processing and/or analyzing samples carried by the sample plates. The sample-processing station is also equipped with data input/output unit. In accordance with the aforementioned U.S. Patent Application, the memory chip can be built into the sample plate. Both data input/output units interact with an electronic memory chip built into each sample plate for loading information into any sample plate, which is processed by the stations for inputting the information into or for retrieving the information from the aforementioned memory chip at any moment of the process. The aforementioned information may contain records of the events history and the current status of the samples and the respective sample plates.

It is understood that in order to perform all the above-described data input and output operations, the sample-processing stations should be computer-controlled. However, it might be difficult to assemble several processing stations into an integrated system for a flexible high throughput sample analysis. This is because normally each individual processing station has software that is not compatible with the software on the other processing stations, especially if processing stations are produced by different manufactures. It is also common for each sample-processing station to maintain its own methods for describing the processes to which the samples are being subjected on this processing station. If different samples have to be analyzed on processing stations based on different methods of data presentation, and if it is necessary to share data between processing stations, then the data is commonly reloaded manually or through a cumbersome digital-to-analog conversion on one station and reverse analog-to-digital conversion on another station. This dramatically decreases sample throughput in the system and increases chances for errors. The situation is even more complicated if an additional station with new sample or result processing capabilities has to be added to the system.

One approach to solving the above problem is to organize cooperation between the manufacturers of the processing stations in order to create common software that will allow incorporation of processing stations of different manufacturers into an integrated system. This is not an easy task in view of the competition between different companies and because different sample-processing stations are often obtained from manufacturers located in different countries. Typically, as a part of this approach, it is necessary to rewrite or substantially modify software for each of the processing stations and to place the final software on a common computer intended to provide centralized control of all individual stations.

For a better understanding of the present trends in unification and standardization of processing stations in the field of biomedical industry, it would be advantageous to consider similar trends in the semiconductor industry. At an early stage of its development, semiconductor production was based on the use of so-called “stand-alone” machines, each of which performed its specific wafer-processing operation under the control of its specific software applicable only to this specific machine. When the number of types and models of wafer-processing machines reached into hundreds, the industry confronted a serious problem due to the incompatibility of the software utilized by machines of different types and produced by different manufacturers. One of the proposals for solving this problem was unification of the software, and for this purpose, the semiconductor machine manufacturers have established a special non-profit organization named SEMATECH that, among other activities, promotes unification and standardization of software for end users of the semiconductor manufacturing equipment. Another approach that was automatically implemented involved combining individual wafer processing stations into so-called cluster machines. A cluster machine is an aggregate of several working processing units controlled from a common computer and, as a rule, served by a common loading/unloading/transporting device, such as an industrial robot.

The ideology of cluster machines has been adopted and is growing within the biomedical industry. For example, it is now a common practice in the biochemical industry to have a single computer for controlling a mass spectrometric sample analyzing station and a chromatographic sample delivery station. Unfortunately, if the number of sample-processing stations exceeds two, it becomes difficult to control and manage the system for high throughput processing from a single computer. Even integration of all station-controlling computers of different processing stations into a single network (such as Ethernet) does not necessary solve the problem, since the user of such a network has to be familiar with the specific software of different processing stations, as well as with the different instructions, data presentation formats, and processing methods inherent to different sample-processing stations.

Attempts have been made in order to integrate software used at different sample-processing stations unified into a system. For example, the Molecular Devices FlexStation™ system developed by Hamilton Co., Nevada, USA was designed for automated, high throughput functional cellular assays, such as calcium flux or membrane potential assays. The FlexStation system includes a fluorescence reader and a fluid transfer system that allows measurement milliseconds before and after addition of a reagent. For each sample of 96-well microplate, the FlexStation requires a box of tips and a reagent microplate. One microplate is processed at a time. Without additional automation, a technician must manually remove used labware from the FlexStation and feed fresh reagent, sample and tips after each processed microplate. As with the aforementioned semiconductor manufacturing cluster machines, the addition of a common industrial robot, such as the MICROLAB® SWAP microplate-handling robot, offers full automation of the FlexStation, allowing for unattended operation by automating all labware loading and unloading steps. In addition, the SWAP improves the throughput of the FlexStation by eliminating downtime, while improving sample processing with barcode reading and consistent operation. The SWAP robot is integrated with the FlexStation using an integration kit for script based programming.

The software of the system is integrated on the basis of the MICROLABVector software that controls most of the Hamilton Company's robots. Vector was designed for improved integration between multiple Hamilton instruments and other common laboratory devices, such as Molecular devices FlexStation, and is available with a specific driver for Molecular Devices' SOFTmax PRO software. This driver provides integrated graphic programming of the FlexStation within the Vector software, allowing for the operation of the SWAP robot through the FlexStation.

However, the aforementioned level of integration has drawbacks resulting from the fact that all stations of the system have to be combined into a network operating from a common computer and have to understand a common software. A situation may arise where the system has to incorporate a new station, which is not compatible with the MICROLABVector software. In that case it would be necessary to write a new program or a new driver in order to match the new station with the system. The problem becomes even more aggravated when the number of new processing stations is more than two.

Yet another complication to automation within biochemical industry can be attributed to the high level of diversity between end-user customer bases, as well as somewhat different sets of skills between individuals. It is also quite common that analytical systems of high and high-to-medium throughput may be spread out territorially. In other words, the users of a system may be physically located in different places and remotely from the processing stations, while the processing stations themselves may be located remotely with respect to each other. For example, an analytical lab from a chemistry department within an academic environment may have to analyze large number of samples prepared by students of the biochemistry department. Both departments process samples by using, computer-controlled stations. Currently, however, it is extremely difficult to combine these stations and their end-users into an efficient and flexible integrated system. Similar situations may be observed in the pharmaceutical industry, where core lab facility may have analytical processing stations for sample analysis, while the samples themselves are generated in smaller labs and assigned to different projects or departments. In some cases, individual processing stations may be quite expensive and may have different sample processing rates, so that combining them into an integrated system in one lab may appear to be economically unjustifiable. In view of the above, at the present time integration of several known computer-controlled processing stations into a single, flexible, automated, and highly efficient sample processing system is not a trivial task. Thus, a demand for finding new ways of combining sample-processing stations into a universal system that would allow simple accumulation and exchange of data between the stations and easy incorporation of a large number of new stations remains topical.

### OBJECTS AND SUMMARY OF THE INVENTION

It is an object of the present invention to provide a versatile system of multiple sample-processing stations with a data organization pattern compatible with stations of different types and manufacturers. It is another object to provide a method of incorporating multiple sample-processing stations into a system for software integration between the different sample-processing stations. It is another object to provide a convenient and easy method for including additional processing stations and additional processing commands into the aforementioned multiple station system. It is a further object of the present invention to provide the aforementioned method and system for high throughput flexible processing of biochemical sample arrays. Still another object is to provide a new and convenient method of data organization in the unified software pattern for a plurality of sample-processing stations combined into a system. Another object is to facilitate interface between sample-processing stations of different types and purchased from different manufacturers.

According to the present invention, a high throughput system for processing arrays of biochemical samples may be composed of individual computer-controlled sample-processing stations or instruments, wherein each individual station is assigned at least one instrument identifier (ID), and a system that may comprise of at least one writing station for specifying a sample processing task for the system. Each sample array that has to be processed in the system is uniquely associated with a specifically allocated electronic memory that can be accessed by the sample-processing stations of the system as well as by at least a single writing station of the system. This memory may be located on memory chips built into or removably attached to sample carriers that carry the samples to be analyzed, or in a location remote from the sample carriers, e.g., in a CPU. The instrument ID contains specific records of executable commands that are stored in the aforementioned memory and comprised of a set of commands or a processing task for controlling and processing the associated sample array on the stations of the system of present invention. In particular, this is achieved by filtering all the commands that define the sample-processing task on each of the processing stations for separating only those commands that have to be executed on each of the stations. The commands are admitted for execution on a particular processing station if the command ID and the processing station ID match.

The commands can be inputted from the writing stations of the system into a sample-processing task associated with the sample electronic memory. The command's name and the command's name ID are associated with each other, and this association is called, for the purpose of the present invention, as the command definition record (CDR). Along with specific commands, the CDR should also contain command IDs for aforementioned filtering process. Input and output of the commands happen due to the user interaction with the writing station where the user provides a command sequence for the processing task while the writing station software automatically supplements the inputted commands with their command's IDs using CDR. The aforementioned CDR may contain any other additional relevant command information, such as a description of command arguments and their designations, as well as a command description for implementation of a graphical user interface. If a command specific CDR is available on the specific writing station of the system, this command can be inputted along with its command ID into the processing task from that station, so unless it is purposely desired to limit input of certain commands from a particular writing station, the distribution of the CDRs is performed to all of the writing stations.

If a system is assembled and managed according to the method of the present invention, it can be easily expanded to include additional processing stations or commands. This is achieved by assigning a specific new ID to the additional station of a new type. Simultaneously with introduction of the new station into the integrated system, new commands are also implemented to the particular process that is carried out on the new station. This is accompanied by creating command definition records as described above, and by updating command definition records on the writing stations of the system of the present invention.

### BRIEF DESCRIPTION OF THE DRAWINGS

FIG. 1 is a general schematic view of the system of the invention that consists of a writing station and two sample-processing stations for sequential processing of samples on sample carriers equipped with memory chip.

FIG. 2 is an example of command presentation in the processing task of the system of the invention.

FIG. 3 is an example of steps for assembling an integrated, flexible, high throughput system of the invention from individual computer-controlled processing stations.

FIG. 4 is a diagram that shows the flow of processing task commands that pass through the working stations of the system and from which appropriated commands are picked up by matching the commands IDs with the station IDs.

FIG. 5 shows an embodiment of the system of the invention with memory chips, which are permanently mechanically attached directly to the sample plates, and that carry processing task information with specific sample processing commands.

FIG. 6 shows a system similar to the one of FIG. 5, in which the memory chips are permanently or removably attached to shuttle-carriers.

FIG. 7 is a schematic view of the system of the invention, in which mechanical association of the electronic memory chips with biochemical arrays or the shuttle carriers or sample plates is replaced by digital pointing to a memory device located remotely from the biochemical arrays.

FIG. 8A is a layout of the system that illustrates the instrument ID assigning step according to one embodiment of the method of the present invention.

FIG. 8B is a layout of the system that illustrates the primary instrument ID assigning step and additional secondary instrument ID assignments according to one embodiment of the method of the present invention.

FIG. 8C is a layout of the system that illustrates the instrument ID assigning step for the case where a subsystem of the invention is formed by two processing stations.

FIG. 9 details the series of steps required for adding a new command according to the method of the present invention.

FIG. 10A shows elements of a CDR according to one embodiment of the invention.

FIG. 10B shows a specific example of a CDR for three commands shown in the flowchart of FIG. 2.

FIG. 11 is a flow chart that illustrates an expansion of the system of the invention by adding a processing station of a new type.

### DETAILED DESCRIPTION OF THE INVENTION

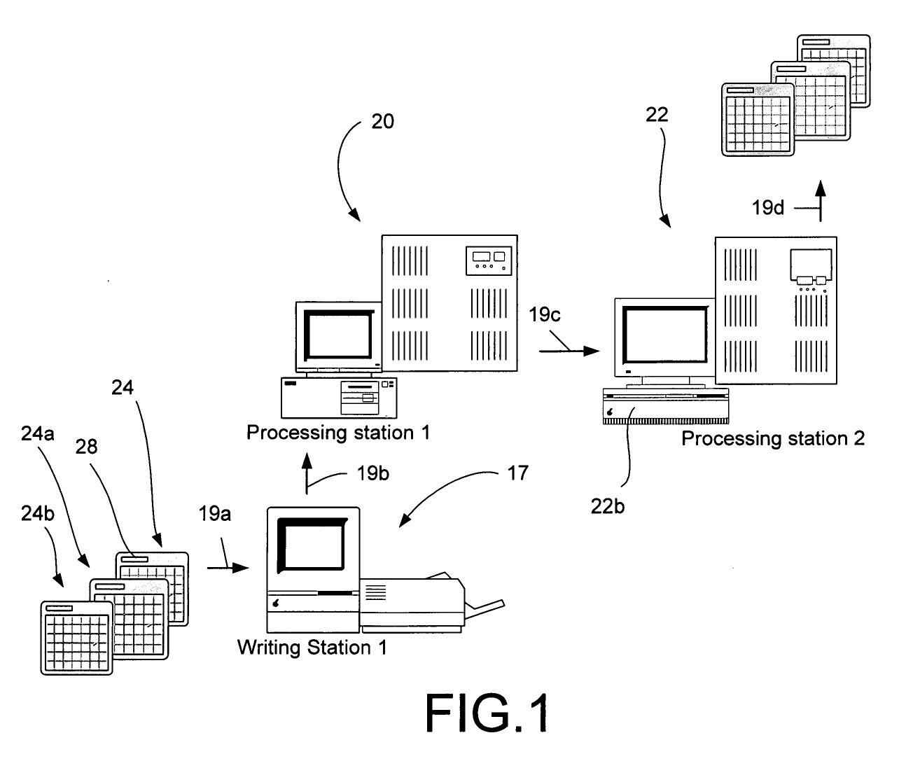

An example of a system of the present invention is shown in FIG. 1, which is a general schematic view of the system. For simplicity of explanation, the system shown in FIG. 1 contains only a single writing station 17 and only two sample-processing stations 20 and 22. Since the processing stations of the present invention are computer-controlled automated stations with station-specific processing hardware, computer and the controlled software, for the purpose of general reference we will call the combination of the controlling computer, the processing hardware, lower level electronic hardware, possibly with additional microprocessors and associated software (firmware) and/or the controlled software on each station as the “executing device” of that station. For example, station 20 may represent a sample distribution station, and station 22 may represent an analyzing station, e.g., an optical spectrometer. Sample carriers 24, 24a, 24b that support a plurality of samples are carried between the stations either by a transporting robot, or by an operator, or can even be send by postal service, as has been described in the aforementioned previous related patent applications of the inventor. Arrows 19a, 19b, 19c, 19d in FIG. 1 show the path of movement of the sample carriers 24, 24a, 24b between the stations.

As has been described in the aforementioned earlier patent applications of the present applicant, each sample carrier 24 is provided with a memory chip 28 that, among other data, contains a set of commands that determine the sequence and nature of processes to which the samples have to be subjected on their path through the stations of the system. More specifically, according to one embodiment of the present invention, each processing station is assigned a specific ID, which is unique for each specific type of processing, and each ID is accompanied by a set of commands that define operations, which have to be performed on the station identified by the attached ID. Each memory chip contains all the ID's with commands associated with these ID's as a part of the complete processing task for the particular sample array. If the system contains several stations of the same types, all stations identical in their type and the processing operation to be performed with the samples may be assigned the same ID. Each station chooses the commands by their ID's. Although the memory chip 28 of each sample plate 24 contains all the commands for all the stations, each station picks up only those commands that are associated with its specific ID and ignores the commands, which do not coincide with its ID. Only a writing station, such as the station 17, can work with all the commands since it functions to input all the commands specified by a user into the memory chip 28 and possibly to check or modify the commands that were pre-specified by another user at another writing station, (not shown) or at the factory, that produced the sample carriers 24. According to the present invention, a writing station contains a command definition record (CDR) file with the description of a subset of commands associated with some stations. Each CDR for each command has to have at least a corresponding ID to indicate to the processing station that this command has to be executed. According to one embodiment of the present invention, the CDR also contains information on the graphical representation of the command for the writing stations. This feature allows one to implement the graphical user interface (GUI) with the same common look on the different writing stations. If a specific writing station does not have a CDR for a specific command, then this command will not be accessible to the user through that station. Therefore, a user can input or edit only those commands that are contained in the CDR file associated with his/her specific writing station. This feature allows one to easily compile a system that provides customers with open access functionality, i.e. a system with limited editing or modification privileges of the commands on those writing stations that are accessible to inexperienced users. If a writing station contains CDRs for all the commands associated with all stations, then the user of this writing station can edit or input any command from a complete command set. This station can be called the administrative (or advanced-user) writing station.

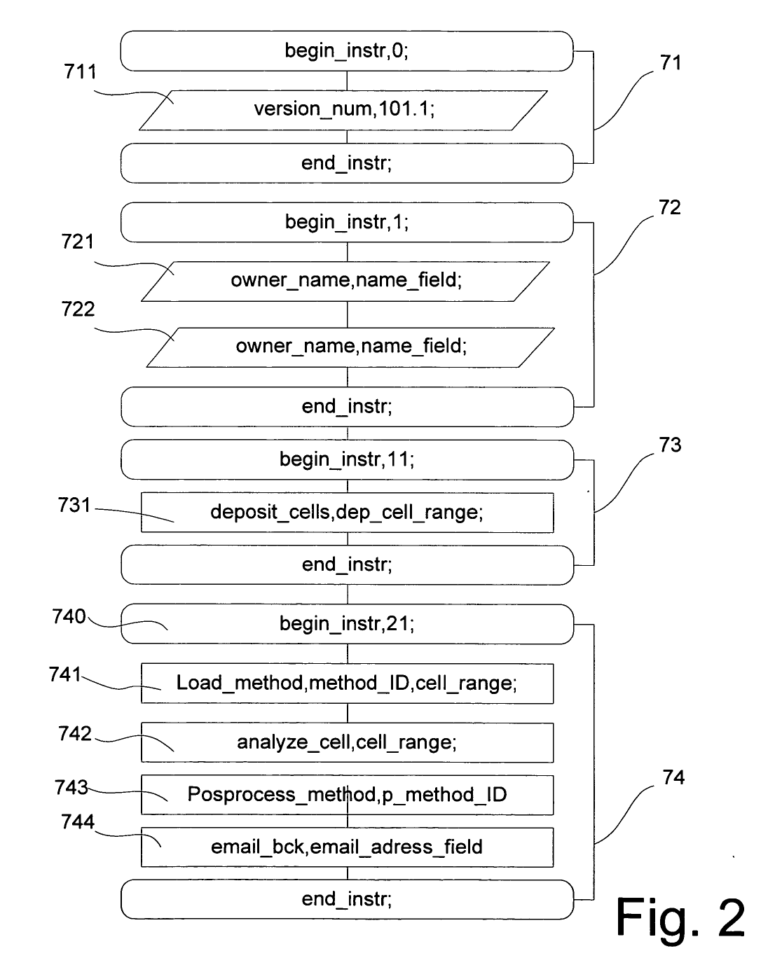

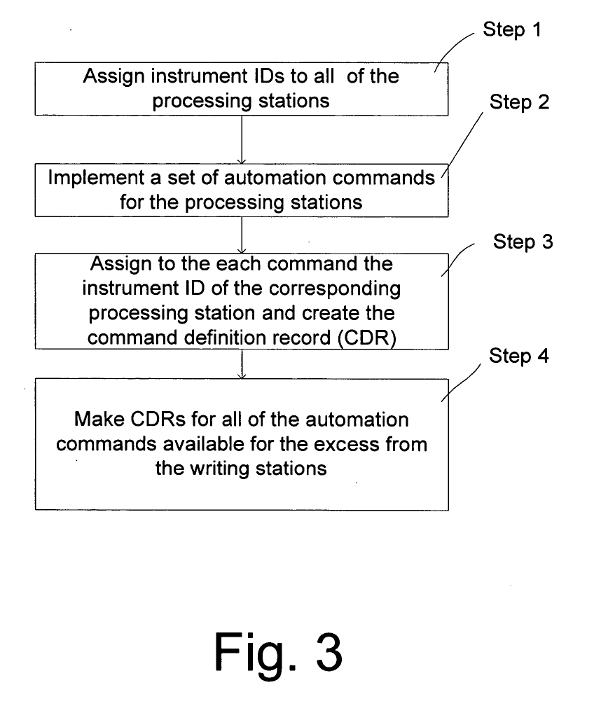

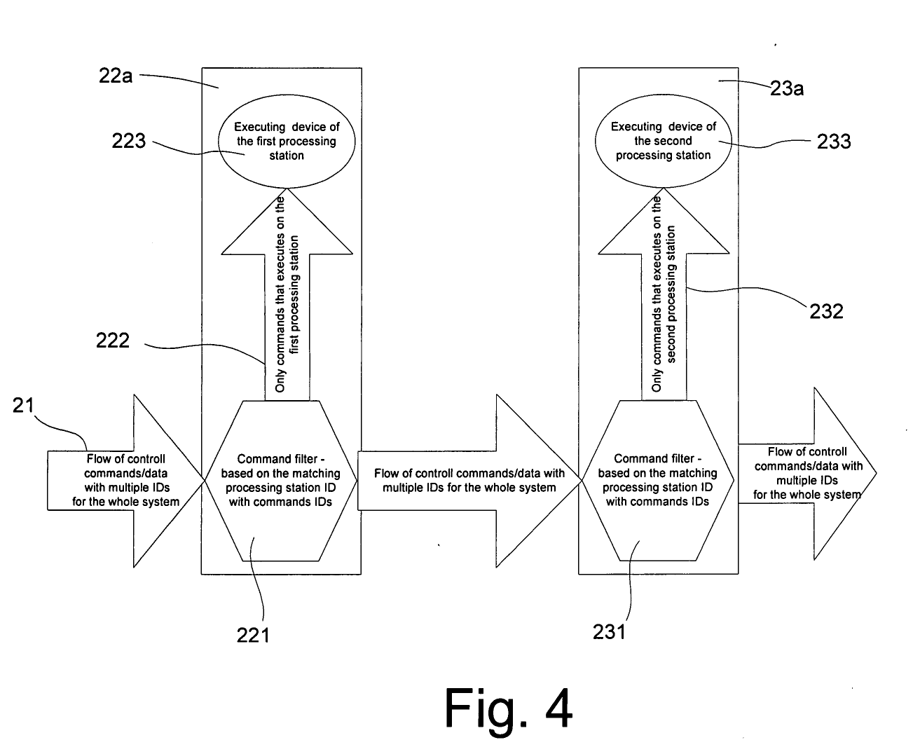

An example of a command-processing task written on the electronic memory is shown in a block-diagram form in FIG. 2. In this example, the bracketed approach is used to specify the commands instrument IDs. In this approach, within the bracket all commands have the same command instrument ID defined by the bracket argument symbols, e.g., all commands that are placed between the opening bracket defined as “begin_instr, <argument>” statement and the closing bracket “end_instr” statement. The brackets 71 have a single command 711 that specifies the current version of the configuration for the whole system. The second pair of brackets 72 in this example is identified with the instrument that is represented by the sample carrier 24, and has two commands 721 and 722, where command 721 specifies the owner of the carrier 24r, while command 722 is designed either to allow or not to allow multiple users of the carrier 24 (FIG. 1) to alter its memory contents. In this example, the bracket pair 73 defines commands for the sample distribution/loading station 20, such as the command 731 that defines the position of the samples that have to be loaded into the biochemical array that is placed in the sample plate. The bracket pair 74 defines commands that are specified to be executed on the processing station with an ID equal to number 21, for example, on a station such as station 22 of FIG. 1. The beginning of the bracket 74 and the command IDs for that bracket are specified in the opening bracket 740. The numerical reference 742 indicates a command that specifies the exact locations of the samples on the sample plate that had to be previously delivered by the sample distribution station 20. For this example, we can also assume that ID 21 was assigned to an analyzing processing station such as station 22. Therefore last-mentioned command bracket 74 is intended for a processing station, such as a spectrometer, that has to analyze a biochemical array. A command designated by the reference numeral 741 defines a specific method intended for the analysis to be performed by the spectrometer. As mentioned previously, the command 742 defines locations of a sample to be analyzed on the biochemical array; the command 743 defines post-processing steps that have to be performed with obtained data; and the command 744 defines that a notification on the completion for the processing have to be sent to all specified e-mail addresses. In this example, the station 22 should have a set of correct pre-prepared operational methods stored or accessible to the computer of that station prior to functioning within the system, so that the command 741 only points out to an appropriate user-defined method from a set of the pre-prepared operational procedures. FIG. 3 shows, in block-diagram form, an example of steps for assembling an integrated flexible high throughput system of the invention from individual computer-controlled processing stations. The illustrated example will relate to the processing of biochemical array samples. The process is started by assigning specific instrument identifications (IDs) to individual processing stations (Step 1 in FIG. 3). According to the method of the present invention, in the next Step 2, all individual processing stations have to be assigned with appropriate controlling commands to be implemented on these stations. All controlling commands have to be assigned with instrument IDs in such a way that each command receives the same instrument ID as the processing station instrument ID that executes the command. This is shown by Step 3. The commands (or the names of the command) have to be matched with their assigned instrument IDs. According to the present invention, all the commands are provided with their CDRs and all data stations are assigned with their instrument Ids. It is further required to provide writing stations with CDRs for the implemented commands, which is shown by Step 4 in FIG. 3. The CDR record for a command contains information for matching the command name or identifier and processing station ID that this command can be executed. In one embodiment, a command definition record (CDR) also includes information on the graphical representation of a command for the user interface when this command is executed on the writing station of the system. In another embodiment, a command definition record (CDR) also includes information on the arguments of the command which can be used to verify users' input on the writing stations of the system of the present invention as described in more details below. According to the method of the present invention, instrument ID's are used to separate and transfer commands from a common flow of commands or processing tasks to commands for the specific processing stations, as shown on FIG. 4. As shown in this figure, the sample carriers, such as carrier 24 (see FIG. 1), can pass though the system of two processing stations 22a and 23a generating common information flow 21 (FIG. 4) of the control commands. The flow of commands 21 is filtered on each of the processing stations (for example on stations indicated by reference numeral 22a and 23a) for separating out those commands that have to be executed on this station. In FIG. 4, the commands picked up by the stations 22a and 23a are designated by reference numerals 222 and 232. The picking-up or filtering of commands from the common flow is based on the principle of retrieving the ID's that correspond to respective commands and on comparing these ID's with the processing station instruments ID's. If the ID's are matched, the commands are submitted for execution on the respective stations. The filtered commands shown In FIG. 4 by reference numerals 222 and 232 are submitted for the execution on the corresponding executive devices 223 and 233 of the processing stations 22a and 23a.

The picking up of commands can be performed by the same computer as the one intended for controlling the operation of the executing device of the station. For example, for the processing station 22 this may be computer 22b, as shown in FIG. 1. Alternatively, this may be a separate computer (not shown).

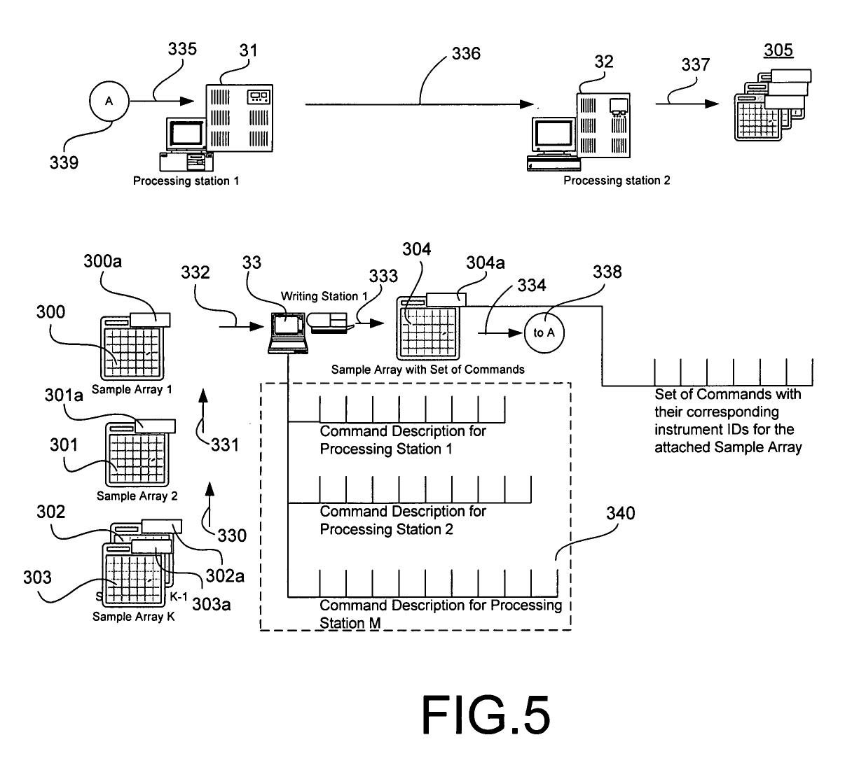

According to the present invention, there are several ways to organize the flow of commands. In the embodiment shown in FIG. 5, the memory chips 300a, 301a, 302a, 303a, and 304a, are permanently mechanically attached directly to the sample plates 300, 301, 302, 303, and 304, respectively. Such sample plates with memory chips are disclosed in pending U.S. patent application Ser. No. 10/615,733 filed on Jul. 9, 2003 by the same applicant.

In the example shown in FIG. 5, for simplicity of the description, the system of the invention consists of two processing stations 31 and 32 and a command writing station 33. All control commands are loaded into the electronic memory chips on the writing station 33 to preprogram processing of the plates 300, 301, 302, 303 . . . . for the processing stations 31 and 32. The processing stations 31 and 32 are equipped with read or read/write devices (not shown) to access the information stored on the memory chips 300a, 301a, 302a, 303a, and 304a of the biochemical arrays 300, 301, 302, 303, and 304. In this embodiment, the writing station 33 is preloaded with a complete set of CDRs, as indicated by reference numeral 340. When a user writes a new command into the electronic memory of the memory chip, e.g., of the chip 300a of the biochemical array 300, this command is recorded on the chip along with its matching instrument ID based on the CDR for the command. Later, when biochemical array arrives to the particular processing station, e.g., station 31 (FIG. 5), the processing station 31 picks up only those commands that are assigned to that station (commands that have an ID matching the station ID), as it has been described above. The arrows 330 to 337 shown in FIG. 5 illustrate the actual movement of the biochemical arrays through the system of the present embodiment. It should be noted that the writing station 33, as well processing stations 31 and 32, can be located remotely from each other, and sample arrays can be transferred to the processing stations by suitable means 338 and 339 (e.g., by postal service, carriers, etc.).

In the embodiment of the invention shown in FIG. 5, the memory chips 300a, 301a, 302a, 303a, and 304a, are permanently mechanically attached directly to the sample plates 300, 301, 302, 303, and 304, respectively. Such sample plates with memory chips are disclosed in pending U.S. patent application Ser. No. 10/706,011 filed on Nov. 10, 2003 by the same applicant, while another U.S. patent application Ser. No. 10/624,399 filed on Jul. 21, 2003 by the same applicant discloses a shuttle-carrier that incorporates a memory chip.

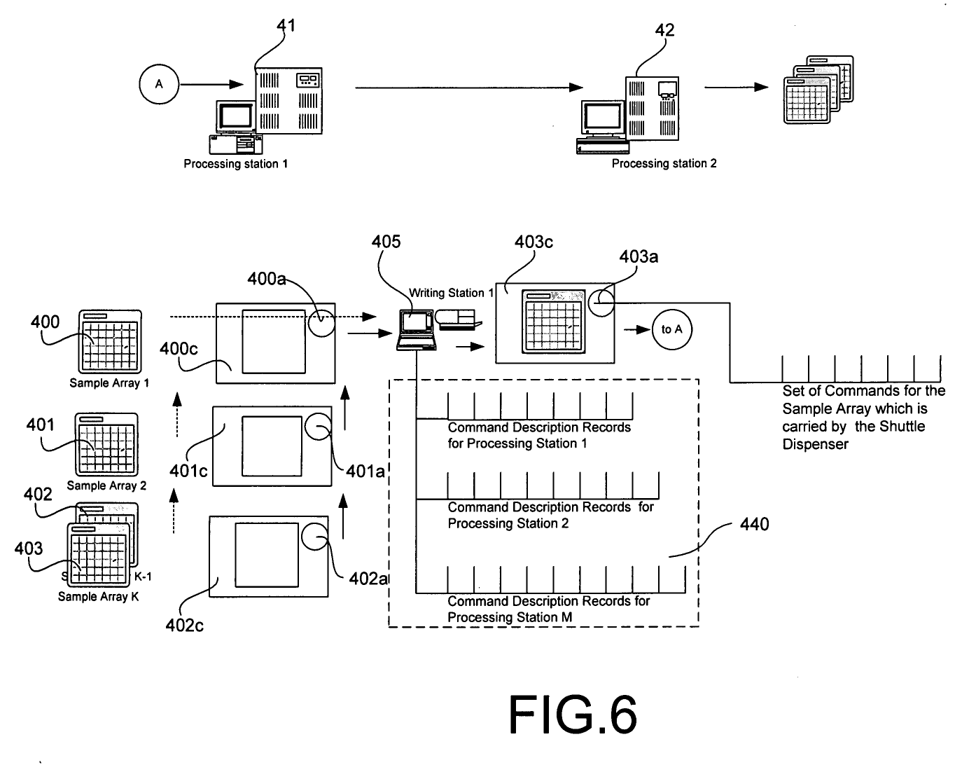

FIG. 6 shows a system similar to the one of FIG. 5, in which the memory chips are permanently attached to shuttle-carriers. Arrows in FIG. 6 illustrate the direction of actual movements of the biochemical arrays and their shuttle-carriers through the system. First, the shuttle-carriers 400c, 401c, 402c, 403c are programmed at writing station 405. Then, the bio-arrays 400, 401, 402, 403 can be attached to the respective carriers 400c, 401 c, 402c, 403c that have an appropriate set of commands and their IDs (that can also be called “processing task”) programmed into the carriers memories on the writing station 405. As in the previous embodiment, writing station 405 is provided with a CDR 440 to supplement user-specified commands with their IDs. The arrays attached to the shuttle carriers are transferred to the first processing station 41 and the command filtering mechanism. Similar to the previous embodiment, each station is assigned only those commands from the common set of the tasks that are due to be performed on that particular station. Then the shuttle-carrier with the biochemical array is transferred to the next processing station 42, which reads, picks up appropriate commands, and executes the selected commands. In this embodiment, the flow of commands comes to the processing stations from the electronic memory devices attached to the shuttle-carriers.

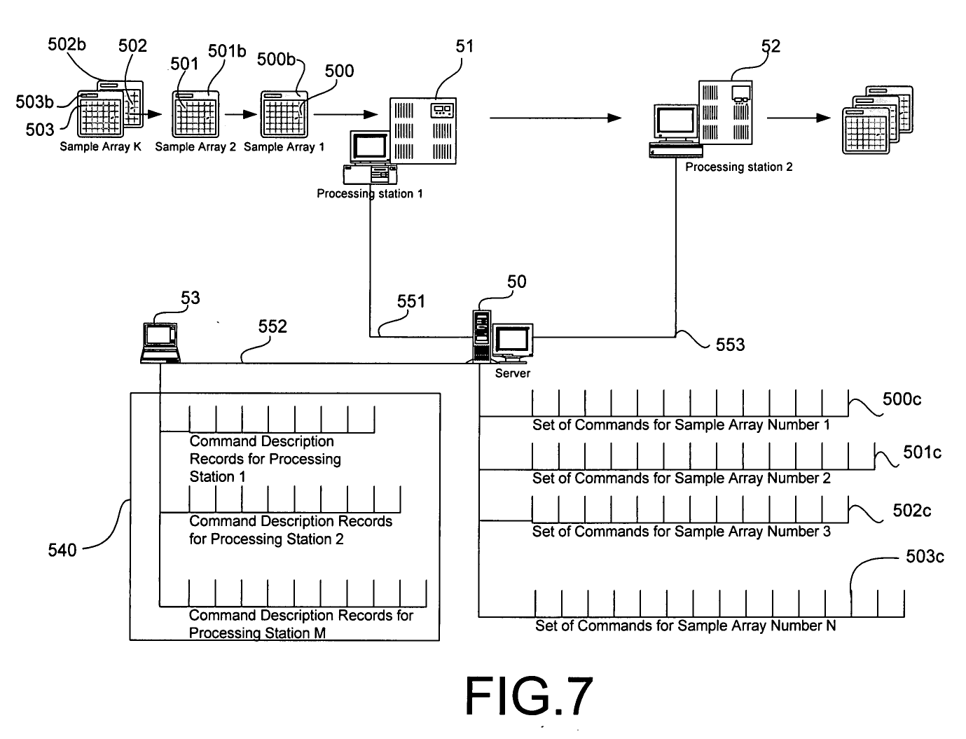

In a third embodiment of the system shown in FIG. 7, mechanical association of the electronic memory chips with biochemical arrays or its shuttle carriers is replaced by digital pointing to a memory device located remotely from the biochemical arrays. Such a system can be called a virtual shuttle-carrier system. In this system, each association with the electronic memory that contains a respective task command for an appropriate individual array is performed by using a specially created pointing record (not shown) located on a common server 50 that provides match between a unique bar code, such as bar codes 500b, 501 b, 502b, 503b attached to the bio arrays 500, 501, 502, 503, respectively, and the electronic memory locations (or records) 500c, 501 c, 502c, 503c on the server 50 (e.g., on the Ethernet server). For example, the aforementioned electronic memory on the server 50 can be written onto the hard drive of that server. Through network lines 551, 552, 553, the server 50 can be connected to all the processing stations 51, 52 and 53 (including read/write and writing stations) of the entire system. As in the first and the second embodiments, the writing station 53 is provided with copies of the CDRs 540. In this case, the writing station 53 writes the task to the server memory that is associated with the specific biochemical arrays or their carriers. The task for each of the biochemical arrays is obtained from the server based on the pointing record and the bar code number, but the operation of the system is fully analogous to the first and second embodiments of the present invention. It is recognized, that locating the electronic memory on a remote server can have certain advantages if a sample array treatment environment is harsh (e.g., high temperature, corrosive medium) and can destroy the memory device if placed directly on the biochemical array. On the other hand, such an arrangement is more vulnerable to failures in the network between the processing stations.

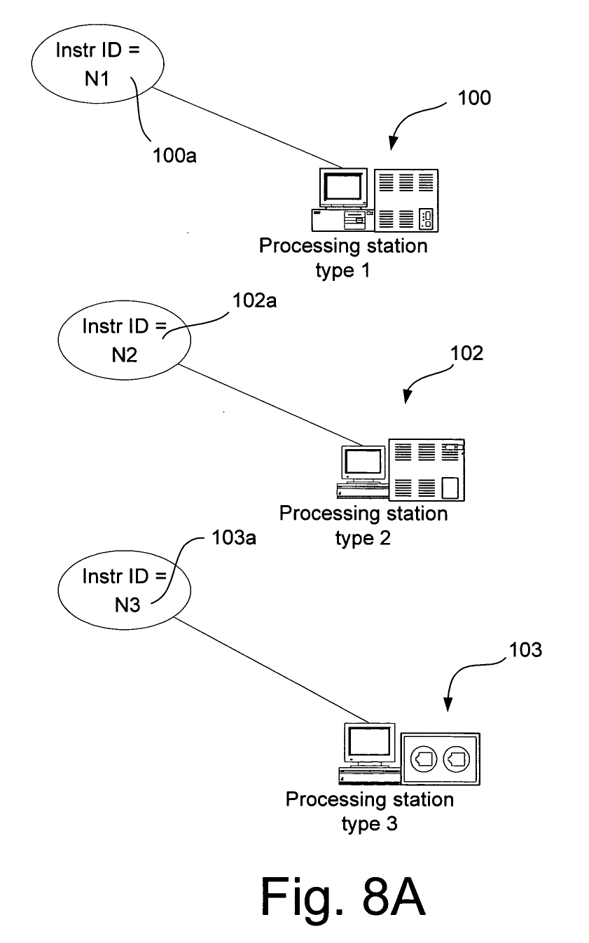

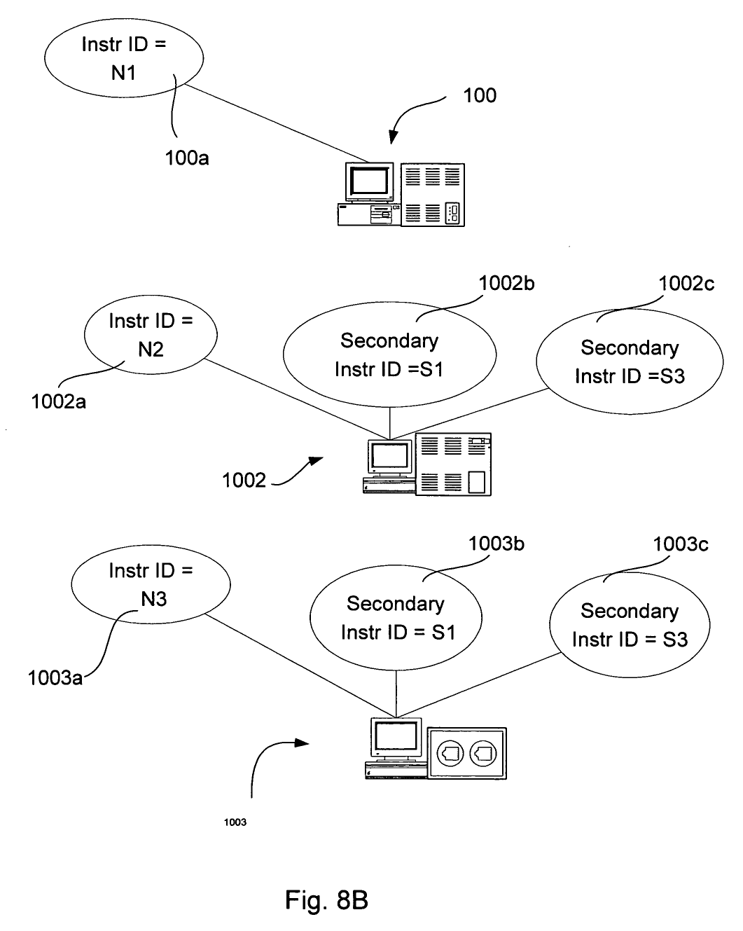

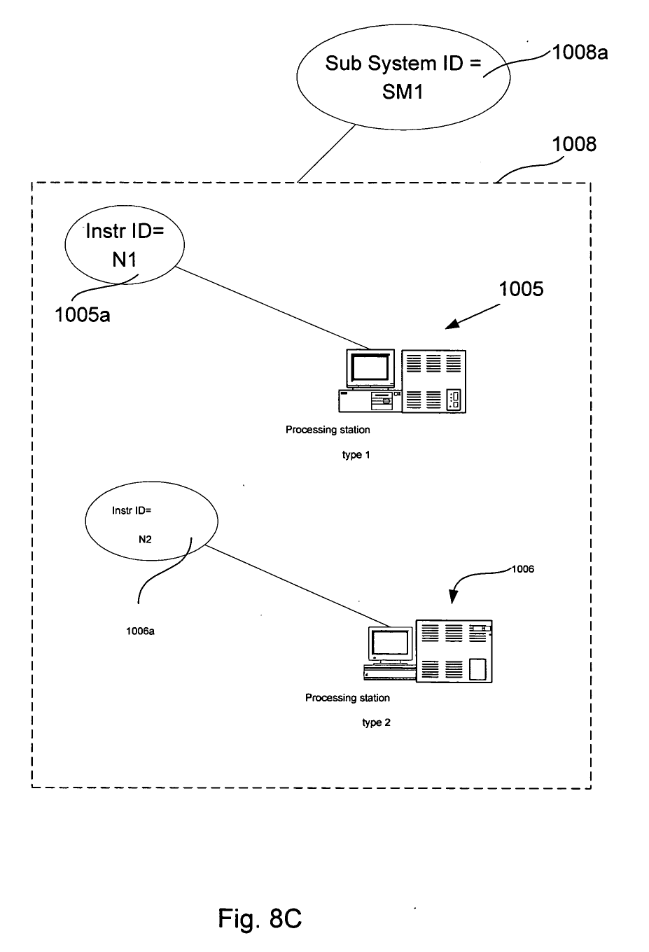

FIG. 8A shows the instrument ID assigning step according to one of the methods of the present invention. According to this embodiment, the processing stations are sorted by types of sample treatment processes and by an implemented set of commands that are to be performed by these stations. In this case, each station type is assigned with at least one unique instrument ID. All the stations of the same type are assigned the same ID, i.e., the station type ID. For example, a processing station of type 1 represented on FIG. 8 by reference numeral 100, can be a sample loading station, and it is assigned with instrument ID=N1 as indicated by the numerical reference 100a. The processing station 102 of type 2 can be a mass spectrometer station and is assigned instrument ID=N2, as indicated by the numerical reference 102a. Station 103 can be an optical spectrometer station and is assigned instrument ID=N3 as indicated by the numerical reference 103a. In general, according to the present invention, two different stations can be attributed generally to one type if they have the same processing functions and the same set of processing commands. In this case, they can be assigned the same ID. In the example illustrated on FIG. 8, all stations have different functionalities, and therefore they are assigned different IDs. However, even if processing stations, e.g., mass spectrometers, are produced by different manufactures, they are considered usually as instruments of different types, since these mass spectrometers are likely to have different instruction/command sets implemented by their manufacturers. On the other hand, mass spectrometers of the same or similar models of the same manufacturer are normally classified as stations of the same type. In conventional practice, however, processing stations may be defined differently, e.g., by the names of processes to be performed on these stations. For example, if the station is an analyzing station equipped with a certain analyzing device, it is common to call this station by the name of the analyzing device belonging to this station, e.g., a station that incorporates a quadrupole mass analyzer will be called a quadrupole mass-analyzing station, and a station that incorporates an ion trap mass analyzer will be called an ion-trap mass analyzing station, etc. In contrast, the method of the invention calls for the type of a spectrometer or a processing station to be based on the set of implemented commands, so irrespective of the conventional name, only those stations will be attributed to a common type that have the same set of commands, while the stations or instruments with different command sets will be attributed to the different type irrespective of the similarity of their processing functions.

According to the present invention, all processing stations of the system have their IDs, and all commands from the flow of commands have their corresponding IDs assigned. It should be noted, however, that commands are only one example of information that can be exchanged or transferred between the different processing and writing stations of the system of the present invention. In order to provide the system with higher flexibility, it is also possible to assign IDs not only to commands, but also to other data objects, e.g., to a set of data obtained as a result of the processing of the sample plate array on a processing station. This can be used to share data in a common way between the processing stations of the system. We may call these sets of data with their IDs as virtual objects of the system. The virtual objects can be physically located on the sample plate carrier memory, such as data device depicted by the numerical reference 400a in the embodiment illustrated in FIG. 6, or these objects can be located in a remote memory location, such as a central computer or server depicted by reference numerical 50 in the embodiment illustrated in FIG. 7.

In one of the embodiments of the present invention, it is also possible to assign additional secondary IDs to the processing stations, as illustrated on FIG. 8b, e.g., the processing station 100 has a unique type specific ID 100a, while processing station 1002 has one type specific primary ID 1002a and additional secondary IDs 1002b and 1002C and also processing station 1003 has a primary ID 1003a and additional IDs 1003b and 1003c. The additional IDs do not have to be unique with respect to the type of the processing station. This feature of additional non-type specific IDs can be especially useful in providing access to the virtual data objects (described above) from multiple stations within the system independently of the station types. The filtering mechanism in this case on each processing stations is still the same as described previously and illustrated in FIG. 4. In other words, an object or command is admitted for execution on a particular station (or executing device), only if a data ID (such as a command ID or a virtual object ID) from the flow of information 21 matches one of the IDs assigned to that station. In the case of the system illustrated on FIG. 8B, the stations 1002 and 1003 have the same secondary IDs for the IDs depicted by the numerical references 1002a and 1003b. This is shown by S1 in FIG. 8B. All the commands, or data, or other virtual objects that would have an ID within the information flow 21 with the value of S1 will be admitted from the information flow to the executive devices on each of the stations 1002 and 1003.

According to one of the embodiments of the present invention, the system can be divided into several sublevels with respect to the information flow. This feature may be beneficial for managing system functions in systems with a large number of stations. In this embodiment, as illustrated in FIG. 8C, several processing stations, such as e.g., stations 1005 and 1006, can be combined into a sample processing sub-system 1008 (that can be considered as a single bigger station), and, according to the method of the present invention, this sub-system 1008 is assigned its own ID 1008a. Similarly to the previously described embodiments, the data from the flow of data is admitted to the subsystem 1008 only if its data ID matches the subsystem ID 1008a. In this case, specific commands of the stations 1005 and 1006 and their IDs become arguments for commands and IDs of a higher level that match the ID of the sub-system 1008a. This feature of the present invention allows one to compile processing systems with different capabilities and degrees of complexity.

It is also possible to impart to the ID a more versatile function, e.g., to introduce a virtual device that defines the routing of the biochemical arrays through the system and possibly also defines the timing of their processing. The ID concept does not exclude the possibility of assigning unique names to each of the processing station of the system, even to identical stations, independently of their types. These names can be used to specify exact routings, e.g., for sample arrays. Such routings can be stored in the aforementioned virtual devices, such as a device 400a shown in FIG. 6. Another virtual object may also be used for logging the steps that have already been performed.

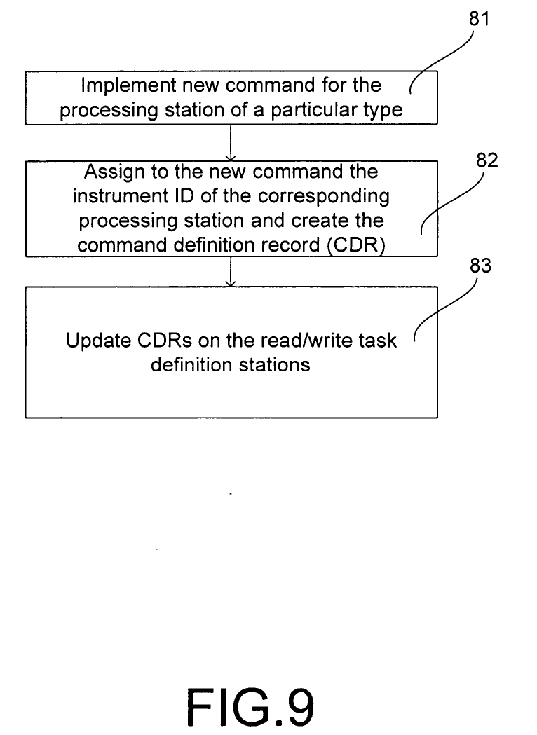

The command structure and the method of the present invention also facilitate the expansion of the system through the addition of new stations to the system and new commands to the existing stations. FIG. 9 shows the series of steps required for adding a new command according to the present invention. First, the command has to be implemented on one of the processing station of the system as indicated by the reference numeral 81. Then, a command definition record CDR has to be created as described above and indicated by a reference numeral 82. Finally, the CDRs have to be updated on the writing processing stations of the system in order to include the new CDR for the new command.

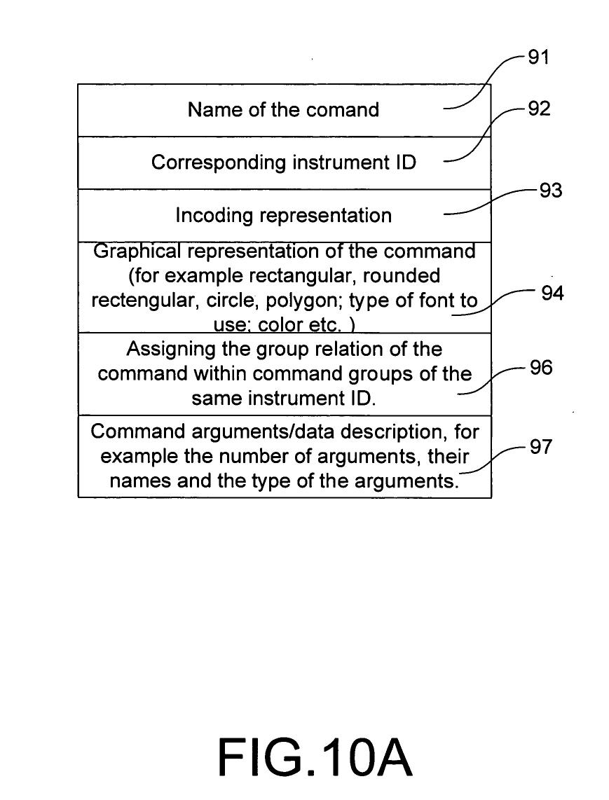

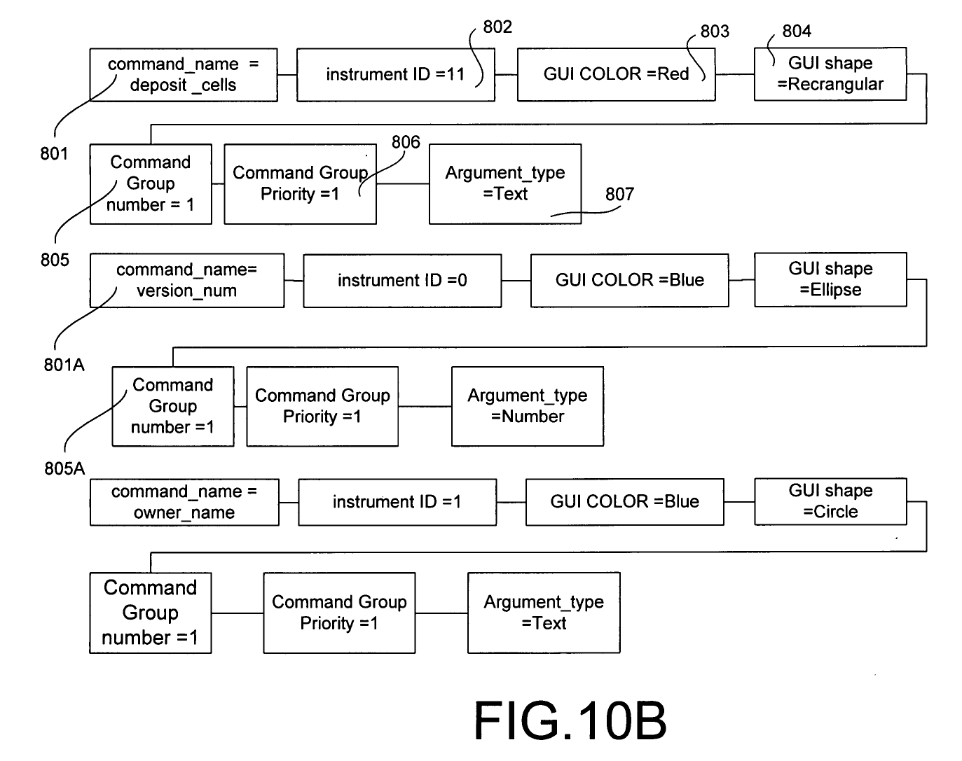

FIG. 10A shows an example of creating a CDR according to one embodiment of the invention, wherein the name of the command, as depicted by the numerical reference 91, is associated with the corresponding processing station ID, as depicted by the numerical reference 92. The CDR also may contain encoding representation information 93, such as a decryption key for the command arguments in case they are encrypted. Also according to one of the embodiments of the present invention, the CDR comprises information 96 on the graphical representation of the command for the graphical user interface (GUI) as well as information on the command arguments 97. The example of the three CDRs for three commands is presented on FIG. 10B, wherein the command with a specific command name (as indicated by reference numeral 801) is assigned a specific instrument ID value (as indicated by the reference numeral 802). The CDR also contains graphical representation information 803, 804, 805, 806 to simplify and standardize user interface on the different writing stations. For example, the fields 803 and 804 define the color and the shape of the command representing button or icon within the GUI on the writing stations. The field 805 defines the grouping of the commands within certain toolbar-menus within GUI. For example, command representation icons for the command 801 and 801a will belong to the same menu-toolbar within GUI, since they have the same value in the fields 805 and 805a. The field 807 may contain information on the number of command arguments and/or their types e.g. integer, text, floating. This feature can be used to check user inputs for the acceptable command arguments. In general, extended information is intended for graphical user interface with a common look on all of the writing stations, which would provide ease of use and the possibility of including new commands into the previously developed groups of commands and their graphical symbols without re-writing the whole GUI software. Similarly, specific examples of the CDR can be described for other commands on FIG. 10b. It is understood that the above description of the CDR is given only as an example.

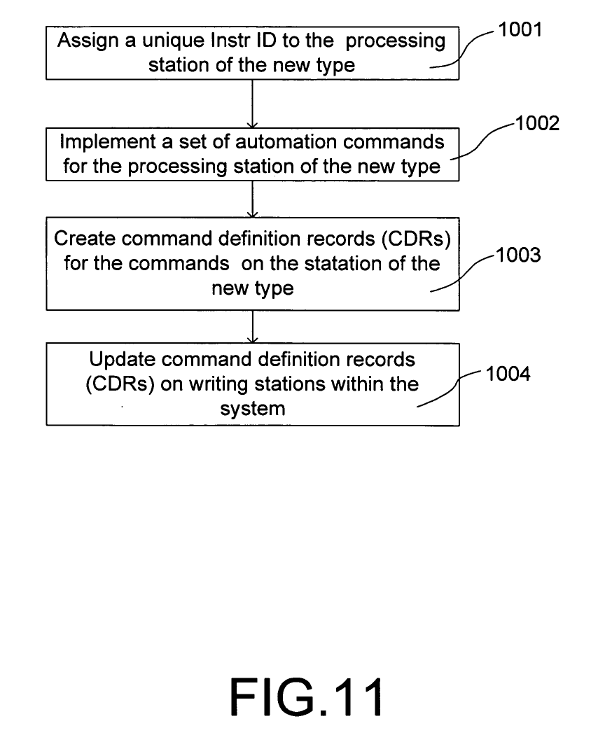

FIG. 11 shows an example of expanding system capabilities by adding a processing station of a new type. According to the present invention, a unique instrument ID has to be assigned to the processing station of a new type, as indicated by the reference numeral 1001. Next, a set of automation commands for the processing station of the new type has to be developed and implemented, as indicated by the reference numeral 1002. Finally, command definition records (CDRs) have to be created for all the commands on the station of the new type, and all command CDRs have to be updated for all of writing processing stations as indicated by reference numeral 1003 and 1004.

Thus, it has been shown that the invention provides: a system of multiple sample-processing stations with a data organization pattern compatible with stations of different types and manufacturers; a method of incorporating multiple sample-processing stations into a system for software integration between the different sample-processing stations; a convenient and easy method for including additional processing stations and commands into the aforementioned multiple station system; the aforementioned method and system for high throughput processing of biochemical sample arrays; a new and convenient method of data organization in the unified software pattern for a plurality of sample-processing stations combined into a system; and a system and method that facilitate interface between sample-processing stations of different types and purchased from different manufacturers.

While the invention has been described with reference to specific embodiments, the description is illustrative of the invention and is not to be considered as limiting the invention. Various modifications and applications may occur to those skilled in the art without departing from the true spirit and scope of the invention. It is recognized here that term biochemical array used in the present invention can be attributed to both solid and liquid samples and not limited to the particular shape, or the dimensions of the specific implementation. Different programming tools and languages can be used for implementing the systems, CDRs, and commands. For example, languages such as XML are particularly suitable for the purposes of the invention.

1. A universal data-exchange system of sample-processing stations comprising:
a plurality of sample-processing stations that may be identical sample-processing stations and different sample-processing stations;
a plurality of sample carriers that carry samples to be processed on said sample stations, each of said sample carriers being associated with memory means that contain information uniquely associated with said sample carriers;
each of said sample-processing stations having at least one executing device for processing said samples;
each of said sample-processing stations having means for reading said information; and
at least one writing station that can read and write said information;
said information comprising specific ID's assigned to each of said sample-processing stations, said specific ID's being different for each of said different sample-processing stations and the same for each of said identical sample-processing stations;
each of said specific ID's being accompanied by a set of commands to be executed by said at least one executing device;
said information containing all said ID's and all sets of said commands associated with said ID's;
said means for reading said information being able to read only those of said all sets of said commands that are associated with an ID of a sample-processing station that contains said means for reading said information;
said at least one writing station being able to read commands associated with all said ID's;
all of said commands being provided with a commands definition records;
each of said commands definition records containing at least a command name and a specific ID of a station to which said ID is assigned.

2. The system of claim 1, wherein said commands definition records further contain information on representation of said commands on said at least one writing station.

3. The system of claim 2, wherein said sample carriers being selected from the group consisting of sample plates that contain samples and shuttle-carriers that support sample plates with samples, said memory means comprising a memory unit placed in a locations selected from the group consisting of each of said sample plates, said shuttle carriers, and a remotely located server with records of said memory digitally linked with each of said sample plates,

4. The system of claim 1, wherein said information may contain a secondary specific ID assigned to each of said sample-processing stations, said secondary specific ID's being different for each of said different sample-processing stations and the same for each of said identical sample-processing stations.

5. The system of claim 2, wherein said sample-processing stations comprising at least one subset of said sample-processing stations capable of exchanging at least a partial information between each other, said sample-processing stations of said at least one subset having the same secondary ID, said partial information being assigned the same ID as said sample-processing stations comprising at least one subset.

6. The system of claim 3, wherein said sample-processing stations comprising at least one subset of said sample-processing stations capable of exchanging at least a partial information between each other, said sample-processing stations of said at least one subset having the same secondary ID, said partial information being assigned the same ID as said sample-processing stations comprising at least one subset.

7. The system of claim 4, wherein said sample-processing stations comprising at least one subset of said sample-processing stations capable of exchanging at least a partial information between each other, said sample-processing stations of said at least one subset having the same secondary ID, said partial information being assigned the same ID as said sample-processing stations comprising at least one subset.

8. The system of claim 3, wherein said samples are biochemical array of samples.

9. The system of claim 4, wherein said samples are biochemical array of samples.

10. The system of claim 5, wherein said samples are biochemical array of samples.

11. The system of claim 7, wherein said samples are biochemical array of samples.

12. The system of claim 1, wherein at least one of said sample-processing stations is a spectrometer.

13. The system of claim 2, wherein at least one of said sample-processing stations is a spectrometer.

14. The system of claim 3, wherein at least one of said sample-processing stations is a spectrometer.

15. The system of claim 4, wherein at least one of said sample-processing stations is a spectrometer.

16. The system of claim 5, wherein at least one of said sample-processing stations is a spectrometer.

17. The system of claim 6, wherein at least one of said sample-processing stations is a spectrometer.

18. The system of claim 7, wherein at least one of said sample-processing stations is a spectrometer.

19. The system of claim 8, wherein at least one of said sample-processing stations is a spectrometer.

20. The system of claim 9, wherein at least one of said sample-processing stations is a spectrometer.

21. The system of claim 10, wherein at least one of said sample-processing stations is a spectrometer.

22. The system of claim 11, wherein at least one of said sample-processing stations is a spectrometer.

23. A method of compiling and managing a universal data-exchange system of sample-processing stations, comprising the steps of:
providing a plurality of sample-processing stations that may be identical sample-processing stations and different sample-processing stations;
providing at least one writing station;
providing a plurality of sample carriers that carry samples to be processed on said sample stations;
providing each of said sample carriers with memory means;
assigning to each of said sample-processing stations a specific ID, which is unique for each of said sample-processing station or to sample-processing stations of an identical type;
associating each said specific ID with a set of commands to be accomplished by a sample-processing station to which said specific ID is assigned;
providing all of said commands with command definition records that contains information for matching said commands to an ID of a station capable of executing said commands;
writing all said ID's and all said sets of commands associated with all of said ID's to each of said memory means on said at least one writing station;
providing each of said sample-processing stations with reading means that can read only those of said all sets of said commands that are associated with an ID of a sample-processing station that contains said reading means;
passing said sample carriers through said sample-processing stations and reading only those of said sets of commands that are associated with said ID specific for said each of said sample-processing stations; and
executing a sample processing operation on each of said sample-processing station in accordance with said sets of commands that are associated with said ID specific for said each of said sample-processing stations.

24. The method of claim 23, wherein said sample carriers being selected from the group consisting of sample plates that contain samples and shuttle-carriers that support sample plates with samples.

25. The method of claim 24, wherein said step of executing said sample processing operation is processing biochemical array samples.

26. The method of claim 24, further comprising the step of providing all of said commands with command definition records.

27. The method of claim 25, further comprising the step of providing all of said commands with command definition records.

28. The method of claim 26, further comprising the step of providing said at least one writing station with functions of writing and reading said information.

29. The method of claim 27, further comprising the step of providing said at least one writing station with functions of writing and reading said information.

30. The method of claim 24, further comprising the step of incorporating into said universal data-exchange system a new sample-processing station by assigning a new ID to said new sample-processing station which is specific for said new sample-processing station and associating said new ID with a new set of commands for controlling a process that have to be fulfilled on said new sample-processing station.

31. The method of claim 25, further comprising the step of incorporating into said universal data-exchange system a new sample-processing station by assigning a new ID to said new sample-processing station which is specific for said new sample-processing station and associating said new ID with a new set of commands for controlling a process that have to be fulfilled on said new sample-processing station.

32. The method of claim 26, further comprising the step of incorporating into said universal data-exchange system a new sample-processing station by assigning a new ID to said new sample-processing station which is specific for said new sample-processing station and associating said new ID with a new set of commands for controlling a process that have to be fulfilled on said new sample-processing station.

33. The method of claim 27, further comprising the step of incorporating into said universal data-exchange system a new sample-processing station by assigning a new ID to said new sample-processing station which is specific for said new sample-processing station and associating said new ID with a new set of commands for controlling a process that have to be fulfilled on said new sample-processing station.

34. The method of claim 28, further comprising the step of incorporating into said universal data-exchange system a new sample-processing station by assigning a new ID to said new sample-processing station which is specific for said new sample-processing station and associating said new ID with a new set of commands for controlling a process that have to be fulfilled on said new sample-processing station.

35. The method of claim 29, further comprising the step of incorporating into said universal data-exchange system a new sample-processing station by assigning a new ID to said new sample-processing station which is specific for said new sample-processing station and associating said new ID with a new set of commands for controlling a process that have to be fulfilled on said new sample-processing station.

36. The method of claim 24, further comprising the step of providing each of said sample-processing stations with a secondary ID for facilitating information exchange between stations with identical secondary ID's.

37. The method of claim 26, further comprising the step of providing each of said sample-processing stations with a secondary ID for facilitating information exchange between stations with identical secondary ID's.

38. The method of claim 27, further comprising the step of providing each of said sample-processing stations with a secondary ID for facilitating information exchange between stations with identical secondary ID's.

39. The method of claim 28, further comprising the step of providing each of said sample-processing stations with a secondary ID for facilitating information exchange between stations with identical secondary ID's.

40. The method of claim 30, further comprising the step of providing each of said sample-processing stations with a secondary ID for facilitating information exchange between stations with identical secondary ID's.
